(19) United States
(12) Patent Application Publication
(10) Pub. No.: US 2024/0193731 A1
(43) Pub. Date: Jun. 13, 2024

(54) FACE REGION BASED AUTOMATIC WHITE BALANCE IN IMAGES

(71) Applicant: Google LLC, Mountain View, CA (US)

(72) Inventors: Liang Liang, San Diego, CA (US); Dohyun Kim, San Mateo, CA (US)

(73) Assignee: Google LLC, Mountain View, CA (US)

(21) Appl. No.: 18/079,826

(22) Filed: Dec. 12, 2022

(51) Int. Cl. G06T 5/00; G06T 7/90; G06V 10/25; G06V 10/75; G06V 40/16

(52) U.S. Cl. CPC G06T 5/001; G06T 7/90; G06V 10/25; G06V 10/751; G06V 40/161

(57) ABSTRACT

Implementations described herein relate to methods, devices, and computer-readable media to automatically adjust white balance in an image. In some implementations, a computer-implemented method includes detecting a face in the image, wherein the face corresponds to a plurality of pixels. The method further includes determining a region of interest (ROI) for the face, wherein the region of interest excludes at least one pixel from the plurality of pixels that correspond to the face. The method further includes performing a face color calculation for the face based on the region of interest for the face. The method further includes adjusting the white balance in the image based on the face color calculation to obtain an output image.

### BACKGROUND

Digital cameras utilize automatic white balance techniques to process a captured image. Some automatic white balance techniques take into account face regions (e.g., one or more human faces in the image) when processing the image. However, if the face region is occluded, such techniques can result in an output image that has unsatisfactory white balance. For example, the face region may be occluded if a person depicted in the image is wearing a face covering (e.g., a mask or other material covering a portion of the face), sunglasses, or other object that occludes a portion of the skin of the face. The unsatisfactory output may include color shifts, e.g., to blue or yellow.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations described herein relate to methods, devices, and computer-readable media to generate images that have automatic white balance adjustments made based on detected face regions in a captured image.

In some implementations, a computer-implemented method to adjust white balance in an image includes detecting, by a processor, a face in the image, wherein the face corresponds to a plurality of pixels; determining a region of interest (ROI) for the face, wherein the region of interest excludes at least one pixel from the plurality of pixels that correspond to the face; performing a face color calculation for the face based on the region of interest for the face; and adjusting the white balance in the image based on the face color calculation to obtain an output image.

Various implementations of the method are described. For example, in some implementations, the method includes comparing a pixel value of each pixel of the face with a set of skin tone region parameters; if the pixel value is in the set of skin tone region parameters, including the pixel in the region of interest; and if the pixel value is not in the set of skin tone region parameters, excluding the pixel from the region of interest.

In some implementations, the method further includes, prior to determining the region of interest, determining a skin tone classification for the face. In some implementations, the method further includes identifying a particular set of skin tone region parameters based on the skin tone classification for the face, and wherein determining the region of interest comprises: comparing a pixel value of each pixel of the face with a set of skin tone region parameters; if the pixel value is in the set of skin tone region parameters, including the pixel in the region of interest; and if the pixel value is not in the set of skin tone region parameters, excluding the pixel from the region of interest. In some implementations, determining the skin tone classification is performed using a skin tone classifier that takes as input the plurality of pixels of the face, and the method further includes preprocessing the plurality of pixels of the face, including adjusting one or more statistics of the image prior to providing the image to the skin tone classifier.

In some implementations, the face is at least partially occluded by a face covering, and the region of interest excludes at least a portion of the face covering. In some implementations, the image includes a plurality of faces, and determining the region of interest and performing the face color calculation are repeated for each of the plurality of faces. In some implementations, the method further includes determining that a particular face of the plurality of faces does not meet a size threshold based on a total number of pixels corresponding to the particular face being less than a threshold number of pixels, wherein the particular face is removed prior to determining the region of interest and performing the face color calculation.

In some implementations, a computing device includes a processor and a memory coupled to the processor, with instructions stored thereon that, when executed by the processor, cause the processor to perform operations. The operations include detecting a face in an image, wherein the face corresponds to a plurality of pixels; determining a region of interest (ROI) for the face, wherein the region of interest excludes at least one pixel from the plurality of pixels that correspond to the face; performing a face color calculation for the face based on the region of interest for the face; and adjusting the white balance in the image based on the face color calculation to obtain an output image.

Various implementations of the computing device are described. For example, in some implementations, the operation of determining the region of interest includes comparing a pixel value of each pixel of the face with a set of skin tone region parameters; if the pixel value is in the set of skin tone region parameters, including the pixel in the region of interest; and if the pixel value is not in the set of skin tone region parameters, excluding the pixel from the region of interest. In some implementations, the operations further include, prior to determining the region of interest, determining a skin tone classification for the face. In some implementations, the operations further include identifying a particular set of skin tone region parameters based on the skin tone classification for the face, and determining the region of interest includes: comparing a pixel value of each pixel of the face with a set of skin tone region parameters; if the pixel value is in the set of skin tone region parameters, including the pixel in the region of interest; and if the pixel value is not in the set of skin tone region parameters, excluding the pixel from the region of interest.

In some implementations, the operation of determining the skin tone classification is performed using a skin tone classifier that takes as input the plurality of pixels of the face, and the operations further include preprocessing the plurality of pixels of the face, wherein the preprocessing includes adjusting one or more statistics of the image prior to providing the image to the skin tone classifier. In some implementations, the image includes a plurality of faces and the operations of determining region of interest and performing face color calculation are repeated for each of the plurality of faces. In some implementations, the method further includes determining that a particular face of the plurality of faces does not meet a size threshold based on a total number of pixels corresponding to the particular face being less than a threshold number of pixels, wherein the particular face is removed from the plurality of faces prior to determining the region of interest and performing the face color calculation.

In some implementations, a non-transitory computer-readable medium has instructions stored thereon that, when executed by a processor, cause the processor to perform operations. The operations include detecting a face in an image, wherein the face corresponds to a plurality of pixels; determining a region of interest (ROI) for the face, wherein the region of interest excludes at least one pixel from the plurality of pixels that correspond to the face; performing a face color calculation for the face based on the region of interest for the face; and adjusting the white balance in the image based on the face color calculation to obtain an output image.

Various implementations of the computer-readable medium are described. For example, in some implementations, determining the region of interest includes comparing a pixel value of each pixel of the face with a set of skin tone region parameters; if the pixel value is in the set of skin tone region parameters, including the pixel in the region of interest; and if the pixel value is not in the set of skin tone region parameters, excluding the pixel from the region of interest. In some implementations, the operations further include, prior to determining the region of interest, determining a skin tone classification for the face. In some implementations, the operations further include identifying a particular set of skin tone region parameters based on a skin tone classification for the face, and determining the region of interest comprises: comparing a pixel value of each pixel of the face with a set of skin tone region parameters; if the pixel value is in the set of skin tone region parameters, including the pixel in the region of interest; and if the pixel value is not in the set of skin tone region parameters, excluding the pixel from the region of interest. In some implementations, the operations further include determining a skin tone classification for the face prior to determining the region of interest, wherein determining the skin tone classification is performed using a skin tone classifier that takes as input the plurality of pixels of the face; and preprocessing the plurality of pixels of the face, including adjusting one or more statistics of the image prior to providing the image to the skin tone classifier.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram of an example network environment which may be used for one or more implementations described herein.

FIG. 2 illustrates an example set of images.

FIG. 3 is a flow diagram illustrating an example method to automatically adjust white balance in an image, according to some implementations.

FIG. 4 illustrates an example set of images with automatic white balance adjustment, according to some implementations.

FIG. 5 illustrates an example image of a face with a region of interest obtained according to some implementations.

FIG. 6 is a block diagram of an example device which may be used for one or more implementations described herein.

### DETAILED DESCRIPTION

Automatic white balance algorithms are used to adjust white balance in an image. Such algorithms may be implemented in a digital camera, such as a smartphone camera, a standalone camera, etc. To improve skin color representation for humans depicted in an image, some cameras automatically determine and utilize a face region of interest (ROI) to adjust white balance calculation.

However, if the image includes one or more faces with facial coverings such as masks, headbands, or other coverings that occlude a portion of the face, the image can have a color shift (e.g., to blue or yellow). This can occur due to the inclusion of image pixels corresponding to such facial covering in a face region of interest that is utilized in automatic white balance calculation. If an incorrect face color calculation is performed due to inclusion of such pixels, a color shift can occur in the output image obtained after application of automatic while balance (AWB) algorithms.

Some implementations described herein relate to techniques to automatically adjust white balance in an image that includes a human face that occluded. Automatic white balance relies on information from the camera (from a captured raw image). Per some implementations described herein, region of interest (ROI) for a face is determined such that the region of interest excludes one or more pixels that correspond to the face but that do not constitute face/skin, such as pixels that correspond to a face mask, sunglasses, or other occluding objects. For example, the region of interest excludes portions of a detected face that are non-skin, e.g., that do not correspond to a skin tone color. The ROI is used to perform a face color calculation for the face. White balance in the image is adjusted based on the face color calculation.

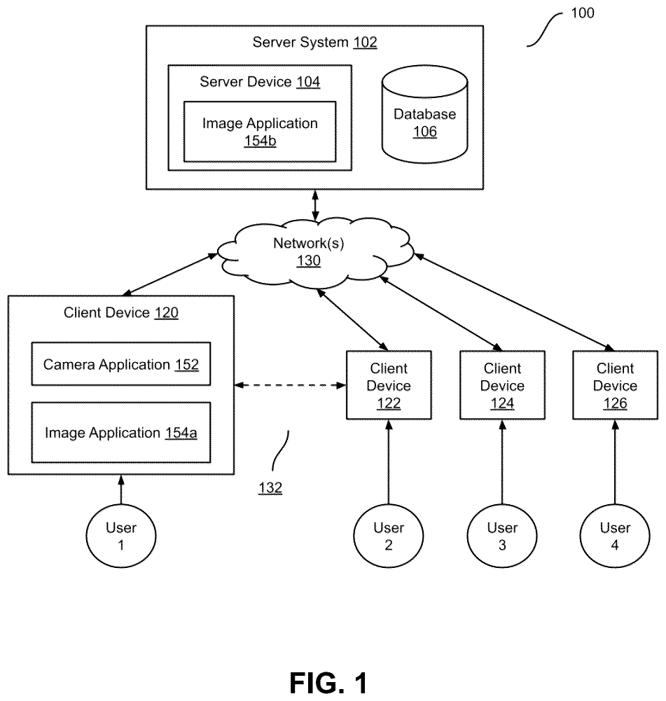

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104 and a database 106 or other storage device. In some implementations, server device 104 may provide image application 154b. In FIG. 1 and the remaining figures, a letter after a reference number, e.g., “154a,” represents a reference to the element having that particular reference number. A reference number in the text without a following letter, e.g., “154,” represents a general reference to embodiments of the element bearing that reference number.

Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication between devices, e.g., using peer-to-peer wireless protocols (e.g., Bluetooth®, Wi-Fi Direct, etc.), etc. One example of peer-to-peer communications between two client devices 120 and 122 is shown by arrow 132.

For ease of illustration, FIG. 1 shows one block for server system 102, server device 104, database 106, and four blocks for client devices 120, 122, 124, and 126. Server blocks 102, 104, and 106 may represent multiple systems, server devices, and network databases, and the blocks can be provided in different configurations than shown. For example, server system 102 can represent multiple server systems that can communicate with other server systems via the network 130. In some implementations, server system 102 can include cloud hosting servers, for example. In some examples, database 106 and/or other storage devices can be provided in server system block(s) that are separate from server device 104 and can communicate with server device 104 and other server systems via network 130.

Also, there may be any number of client devices. Each client device can be any type of electronic device, e.g., desktop computer, laptop computer, portable or mobile device, cell phone, smart phone, tablet computer, television, TV set top box or entertainment device, wearable devices (e.g., display glasses or goggles, wristwatch, headset, armband, jewelry, etc.), personal digital assistant (PDA), media player, game device, etc. Some client devices may also have a local database similar to database 106 or other storage. In some implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., a social network service or other type of network service, implemented on server system 102. For example, respective client devices 120, 122, 124, and 126 may communicate data to and from one or more server systems e.g., server system 102.

In some implementations, the server system 102 may provide appropriate data to the client devices such that each client device can receive communicated content or shared content uploaded to the server system 102 and/or a network service. In some examples, users U1-U4 can interact via audio or video conferencing, audio, video, or text chat, or other communication modes or applications.

A network service implemented by server system 102 can include a system allowing users to perform a variety of communications, form links and associations, upload and post shared content such as images, text, video, audio, and other types of content, and/or perform other functions. For example, a client device can display received data such as content posts sent or streamed to the client device and originating from a different client device via a server and/or network service (or from the different client device directly), or originating from a server system and/or network service. In some implementations, client devices can communicate directly with each other, e.g., using peer-to-peer communications between client devices as described above. In some implementations, a “user” can include one or more programs or virtual entities, as well as persons that interface with the system or network.

In some implementations, any of client devices 120, 122, 124, and/or 126 can provide one or more applications. For example, as shown in FIG. 1, client device 120 may provide camera application 152 and an image application 154a. Client devices 122-126 may also provide similar applications.

Camera application 152 may be implemented using hardware and/or software of client device 120. In some implementations, camera application 152 may enable a user to activate a sensor (e.g., one or more front cameras, one or more rear cameras, or other cameras) of client device 120. In some implementations, upon user input, camera application 152 may capture an image. In some implementations, the image may be captured as a raw image, e.g., where light sensed by the sensor is stored as raw statistics, e.g., color values for red, green, and blue for pixels of the raw image. In some implementations, camera application 152 may automatically process the raw image to perform operations such as automatic white balance, automatic brightness control, automatic focus, etc. based on the sensor data (raw statistics) to generate an output image.

Image application 154a may be implemented using hardware and/or software of client device 120. In different implementations, image application 154a may be a standalone client application, e.g., executed on any of client devices 120-124, or may work in conjunction with image application 154b provided on server system 102. Image application 154a and image application 154b may provide various functions related to images and/or videos. For example, such functions may include one or more of capturing images or videos using a camera, performing image or video editing (e.g., automatic white balance adjustment), analyzing images or videos to associate one or more tags, storing images or videos in a library or database, etc.

In some implementations, image application 154 may enable a user to manage the library or database that stores images and/or videos. For example, a user may use a backup functionality of image application 154a on a client device (e.g., any of client devices 120-126) to back up local images or videos on the client device to a server device, e.g., server device 104. For example, the user may manually select one or more images or videos to be backed up, or specify backup settings that identify images or videos to be backed up. Backing up an image or video to a server device may include transmitting the image or video to the server for storage by the server, e.g., in coordination with image application 154b on server device 104.

In some implementations, client device 120 may include one or more other applications (not shown). For example, the other applications may be applications that provide various types of functionality, e.g., calendar, address book, e-mail, web browser, shopping, transportation (e.g., taxi, train, airline reservations, etc.), entertainment (e.g., a music player, a video player, a gaming application, etc.), social networking (e.g., messaging or chat, audio/video calling, sharing images/video, etc.) and so on. In some implementations, one or more of other applications may be standalone applications that execute on client device 120. In some implementations, one or more of the other applications may access a server system, e.g., server system 102 that provides data and/or functionality of the other applications.

A user interface on a client device 120, 122, 124, and/or 126 can enable the display of user content and other content, including images, video, data, and other content as well as communications, privacy settings, notifications, and other data. Such a user interface can be displayed using software on the client device, software on the server device, and/or a combination of client software and server software executing on server device 104, e.g., application software or client software in communication with server system 102. The user interface can be displayed by a display device of a client device or server device, e.g., a touchscreen or other display screen, projector, etc. In some implementations, application programs running on a server system can communicate with a client device to receive user input at the client device and to output data such as visual data, audio data, etc. at the client device.

Other implementations of features described herein can use any type of system and/or service. For example, other networked services (e.g., connected to the Internet) can be used instead of or in addition to a social networking service. Any type of electronic device can make use of features described herein. Some implementations can provide one or more features described herein on one or more client or server devices disconnected from or intermittently connected to computer networks. In some examples, a client device including or connected to a display device can display content posts stored on storage devices local to the client device, e.g., received previously over communication networks.

An image as referred to herein can include a digital image having pixels with one or more pixel values (e.g., color values, brightness values, etc.). An image can be a still image (e.g., still photos, images with a single frame, etc.), a dynamic image (e.g., animations, animated GIFS, cinemagraphs where a portion of the image includes motion while other portions are static, etc.), or a video (e.g., a sequence of images or image frames that may include audio). While the remainder of this document refers to an image as a static image, it may be understood that the techniques described herein are applicable for dynamic images, video, etc. For example, implementations described herein can be used with still images (e.g., a photograph, or other image), videos, or dynamic images.

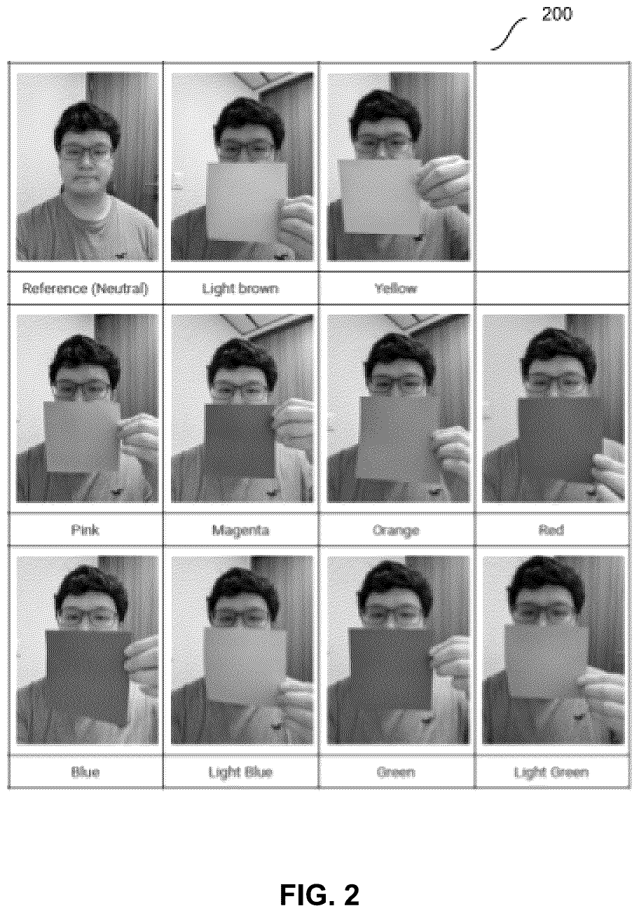

FIG. 2 illustrates an example set of images captured using a camera and to which conventional automatic white balance has been applied (without accounting for face regions and/or coverings). The image in the top-left corner depicts a reference or neutral image where the person does not have a face covering. The remainder of the images in FIG. 2 simulate a person wearing face covering.

The face in the remainder of the images (other two images in the top row and the images in the second and third row) is covered with a piece of paper with different colors. In all of the images, when a face region of interest (ROI) is detected, the colored paper constitutes a portion of the detected face ROI. Upon comparison of each image to the reference image on the top left, a blue shift is observed when the face is covered with red objects as depicted in the second row (Pink/Magenta/Orange/Red) and a yellow shift is observed when the face is covered with green or blue objects as depicted in the third row (Green, Light Green, Blue, Light Blue). However, for light brown and yellow objects whose color is similar to the skin tone of the face, a slight, non-significant color shift is observed (not shown).

A root cause is that the face color that is estimated based on the face ROI is skewed because of the object (piece of paper in this case, but any face covering such as masks, headbands, etc.) inside the face ROI that does not match the true skin tone of the face. The skew affects automatic white balance adjustment algorithms that rely on accurate color calculation for faces, thus affecting the output image after face color aware automatic white balance adjustment is performed.

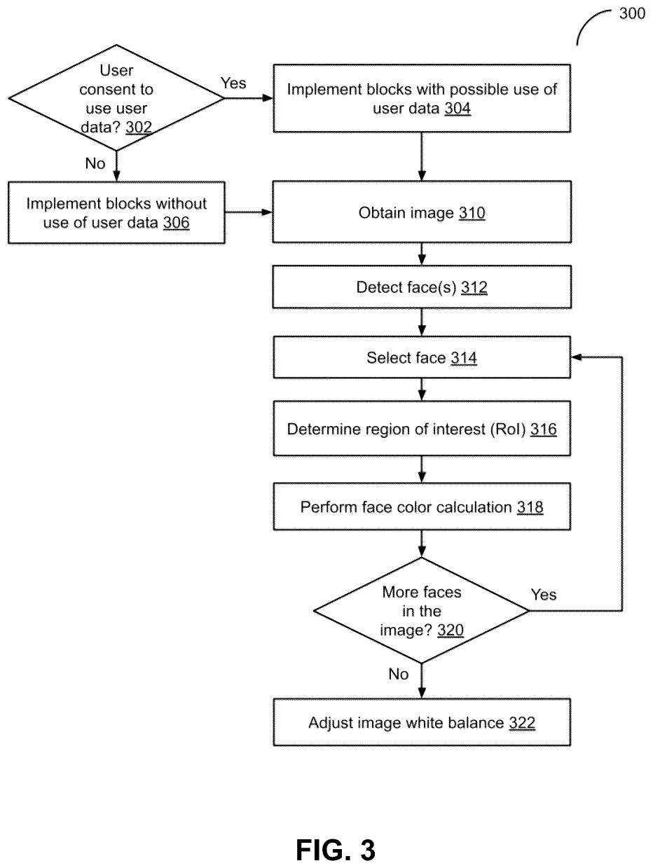

FIG. 3 is a flow diagram illustrating an example method 300 to automatically adjust white balance in an image, according to some implementations. In some implementations, method 300 can be implemented, for example, on a server system 102 as shown in FIG. 1. In some implementations, some or all of the method 200 can be implemented on one or more client devices 120, 122, 124, or 126 as shown in FIG. 1, one or more server devices, and/or on both server device(s) and client device(s). In some implementations, method 300 may be implemented in software, e.g., as part of camera application 152 and/or image application 154.

In described examples, the implementing system includes one or more digital processors or processing circuitry (“processors”), and one or more storage devices (e.g., a database 106 or other storage). In some implementations, different components of one or more servers and/or clients can perform different blocks or other parts of the method 300. In some examples, a first device is described as performing blocks of method 300. Some implementations can have one or more blocks of method 300 performed by one or more other devices (e.g., other client devices or server devices) that can send results or data to the first device.

In some implementations, the method 300, or portions of the method, can be initiated automatically by a system. In some implementations, the implementing system is a first device. For example, the method (or portions thereof) can be periodically performed, or performed based on one or more particular events or conditions. For example, the method can be performed upon a camera of a user device (e.g., a smartphone, a tablet, a laptop/desktop computer, a standalone digital camera, etc.) capturing an image. In some implementations, the method can be performed upon a new image being acquired on a user device, e.g., downloaded to the user device or otherwise added to storage on the user device. In some implementations, the method can be performed upon detecting initiation of video capture on a user device.

Method 300 may begin at block 302. At block 302, it is determined whether user permissions have been obtained to use user data in method 300 (blocks 310-322) as described herein. For example, user data for which permission is obtained can include images stored on a client device (e.g., any of client devices 120-126) and/or a server device, image metadata, user data related to the use of an image application, other image-based creations, etc. The user is provided with options to selectively provide permission to access such user data. For example, a user may choose to provide permission to access all of the requested user data, any subset of the requested data, or none of the requested data. One or more blocks of the methods described herein may use such user data in some implementations.

If it is determined at block 302 that user permissions are sufficient, block 302 is followed by block 304. At block 304, it is determined to process the blocks of method 300 by accessing user data as permitted by the user. For example, blocks 310-322 are performed with selective access to user data as permitted by the user. In some implementations, the user may be provided additional prompts to provide access to user data or to modify permissions. Block 304 may be followed by block 310.

If it is determined at block 302 that permissions provided by the user are insufficient, block 302 is followed by block 306. At block 306, blocks of method 300 are set up to be processed without use of user data. Alternatively, e.g., if the user indicates their denial of permission, the method ends at block 306 and blocks 310-322 are not performed. Block 306 may be followed by block 310.

At block 310, an image is obtained. For example, the image may be captured by a device camera of a user device (any of devices 120-126). In another example, the image may be obtained by retrieving a previously captured image stored on the user device. In some examples, the image may be a single image. In some implementations, the image may be a frame of a video. Block 310 may be followed by block 312.

At block 312, human faces in the image are detected. For example, an image may be detected to include no human faces, one human face, two human faces, or any other number of human faces. Face detection is performed with specific user permission and the user is provided with options to turn off face detection (e.g., for individual images, for a set of images, or as a device-wide setting). If the user denies permission to perform face detection, block 312 is not performed and AWB adjustment is carried out without incorporating a face color calculation.

If the user permits face detection, one or more faces are detected in the image. Each detected face may correspond to a plurality of pixels of the image. In some implementations, face detection may be performed such that each detected face meets a size threshold, e.g., defined as a threshold number of pixels. For example, if a face detection technique detects faces that have a size less than the threshold (total number of pixels of the face is less than the threshold number of pixels), such faces are removed from the detected faces prior to performing blocks 314-322.

In some implementations, user permission may be obtained to determine whether a detected face is a familiar face. Such determination may be based on face recognition techniques that determine whether a face matches a known face. For example, a familiar face may be a face that appears in a plurality of images captured by and/or stored on the user device. If the detected face is a familiar face, in some implementations, a skin tone classification for the detected face may be obtained. For example, with user permission, the skin tone classification may be stored in association with one or more familiar faces, e.g., by image application 156. In some implementations, skin tone classification may include a plurality of classes, e.g., {light, medium, dark}, {light, medium, dark, very dark}, etc. In some implementations, each skin tone classification may be associated with a respective set of skin tone region parameters. For example, such parameters may specify a range of pixel values within which the pixels of a face region should lie for a face to be assigned that skin tone classification. Block 312 may be followed by block 314.

At block 314, a particular face is selected from the human faces detected in block 312. faces that don't meet the size threshold are excluded from selection. Block 314 may be followed by block 316.

At block 316, a region of interest (ROI) is determined for the selected face. The region of interest excludes pixels from the face that correspond to a face covering or other non-skin regions. In some implementations, the face may be at least partially occluded by a face covering and the region of interest is determined that excludes at least a portion of the face covering.

In some implementations, a pixel value of each pixel of the plurality of pixels of the face is compared with a set of skin tone region parameters. The set of skin tone region parameters may be selected such that values that fall within a human skin tone are included while other values are excluded. In some implementations, if the pixel value of the pixel is in the set of skin tone region parameters, the pixel is included in the region of interest, and if the pixel value is not in the set of skin tone region parameters, the pixel is excluded from the region of interest.

In some implementations, prior to determining the region of interest, a skin tone classification may be determined for the face. For example, if the face is a familiar face, the skin tone classification, the stored skin tone classification may be retrieved.

In some implementations, determining the skin tone classification may be performed using a skin tone classifier that takes as input the plurality of pixels of the face. In these implementations, the method further includes preprocessing the plurality of pixels of the face, wherein the preprocessing includes adjusting one or more statistics of the image prior to providing the image to the skin tone classifier. In some implementations, the skin tone classifier may be a trained machine learning model that takes the image as input and outputs a skin tone classification for the image. For example, the classification may be selected from a set {light, medium, dark} or a set {light, medium, dark, very dark}, or other classifications. The machine learning model may be trained using supervised learning where training images (for which permission has been obtained) and groundtruth skin tone classification (label) for each training image is provided as input to the machine learning model during training.

In some implementations, the skin tone classification may be utilized to determine the region of interest. To determine the region of interest using the skin tone classification, a pixel value of each pixel of the face may be compared with the set of skin tone region parameters for the skin tone classification. If the pixel value is in the set of skin tone region parameters, the pixel is included in the region of interest and if the pixel value is not in the set of skin tone region parameters, the pixel is excluded from the region of interest.

The use of skin tone classification may enable excluding regions that are within an overall set of skin tone region parameters determined across the entire range of human skin tone, but that are not within the set skin tone region parameters for the skin tone classification for the particular face. With skin classification specific set of region parameters, face coverings or occluding objects that are within the entire range (e.g., orange colored skin coverings) are removed from the ROI if the pixels that correspond to such objects are not within the skin classification specific set of region parameters. In some implementations, instead of excluding potentially non-skin regions for the ROI, a respective weight may be assigned to each pixel (based on the proximity of the pixel value to the skin tone region parameters) and the weight may be provided as input during face color calculation and/or adjusting the image white balance. Block 316 may be followed by block 318.

At block 318, face color calculation is performed for the region of interest. By performing face color calculation for the region of interest, non-skin regions (e.g., face masks, bandana, other facial covering etc.) that can skew color calculation in later stages of processing the image (e.g., automatic white balance determination) are filtered out, thus enabling more accurate face color. In some implementations, the ROI may be further analyzed, e.g., to remove pixels that are at or near a face boundary. In some implementations, the face color calculation may be based on the ROI that excludes non-skin regions. In implementations where the ROI includes pixels that may be a non-skin region (e.g., multiple pixels of the detected face, each with a corresponding weight), the face color calculation is based on the respective weight assigned to each pixel.

In some implementations, face color calculation may be performed as follows. For pixels in the region of interest (faceStats) for each face, an average red over green (R/G) value (face.rg_{avg}) and an average blue over green (B/G) value (face.bg_{avg}) is calculated. The calculated values are used to perform a lookup in a lookup table (LUT, a precomputed table based on prior images) to obtain an average color value (face.cct_{avg}) and radius (distance) for the face. A ratio of the pixel values for the region of interest (face region) over that for the entire image is obtained. A face weight associated with the face is determined based on a tuning header and the ratio. The tuning header is based on pre-classified skin types (e.g., light, medium, dark, very dark). The obtained face weight and average face color value for each face are used to compute the face color. Below is example pseudocode for face color calculation:

$$for each face in faces : faceStats ← \{ stats ∈ face . statsList \vert stat is valid ⋀ stat is inside RoI R \}$$

$$face . {rg}_{avg} ← {\sum }_{stat ∈ faceStats} stat . rg$$

$$face . {bg}_{avg} ← {\sum }_{stat ∈ faceStats} stat . bg$$

$$face . {cct}_{avg} , face . {radius}_{avg} ← LUT ( face . {rg}_{avg} , face . {bg}_{avg} )$$

$$ratio ← \frac{\vert faceStats \vert}{number of all stats in the image}$$

$$face . weight ← interpolate ( tuningHead . faceRatioWeights , ratio )$$

After face.weightis calculated for each face, calculate face color for each face as:

$$faceCCT ← ( {\sum }_{face ∈ faces} face . {cct}_{avg} \times face . weight ) / ( {\sum }_{face ∈ faces} face . weight )$$

As can be seen from the pseudocode (first line), for pixels in the face region, only such stats that are within the region of interest are taken into account for the face color calculation. This prevents skew (e.g., shift in color) in the face in further processing such as automatic white balance determination. Block 318 may be followed by block 320.

At block 320, it is determined if the image includes more faces that have not been processed to perform face color calculation. If the image includes more faces, block 320 is followed by block 314. If it is determined that the image does not include more faces, block 320 is followed by block 322.

At block 322, image white balance is adjusted based on the face color calculation. For example, output of the face color calculation and pixel values for other parts of the image may be provided as input to an automatic white balance (AWB) algorithm. An output image is obtained after the adjustment.

By determining a region of interest that corresponds to skin of the face and that excludes non-skin regions in the image that may correspond to a face covering such as a mask, a headband, sunglasses, or other objects, the described techniques can provide an output image that has an accurate skin tone after the white balance adjustment. Further, the ROI for a detected face that has no face covering includes all pixels of the detected face, and thus, the output image has accurate skin tone for such faces as well. If an image has a plurality of faces, some with a face covering and some without, the described techniques ensures that white balance adjustment is performed taking into account such faces and that the output image accurately reflects the skin tone for each face. Still further, if particular faces in the image are below a threshold size (e.g., as may happen when a bystander in the background is inadvertently captured in an image), the particular faces are not taken into account when performing skin tone aware automatic white balancing, thus preventing such faces from impacting the output image. The use of ROI prevents non-skin pixels of the detected face skewing the face color calculation and prevents downstream effects when automatic white balance is performed to generate an output image.

The described techniques have several technical benefits. The techniques enable generating output images that accurately represent skin tone of human faces in the scene, even when skin regions are partially occluded by a face covering or other object. The techniques are upstream from AWB algorithms and do not require adjustments to such algorithms. Further, the techniques can generate an improved output image (with more accurate skin tone) for images that depict any number of human faces and for images where certain faces may be occluded due to face coverings while other faces may not be occluded.

Various blocks of method 300 may be combined, split into multiple blocks, or be performed in parallel. For example, blocks 314-318 may be performed in parallel for multiple faces in the image.

In some implementations, method 300 may be used to perform automatic white balance adjustment for a video. In these implementations, the image may be an image frame of the video. In these implementations, consistency of skin tone for a face across multiple image frames may be maintained by denoting a face as a familiar face (e.g., depicted in one or more prior frames), by use a temporal filter (e.g., that ensures consistent skin tone classification for each detected face across multiple frames of the video), etc.

Method 300, or portions thereof, may be repeated any number of times using additional inputs. For example, method 300 may be repeated while video capture is active, until AWB adjustment has been applied to the images obtained in block 302 to generate corresponding output images.

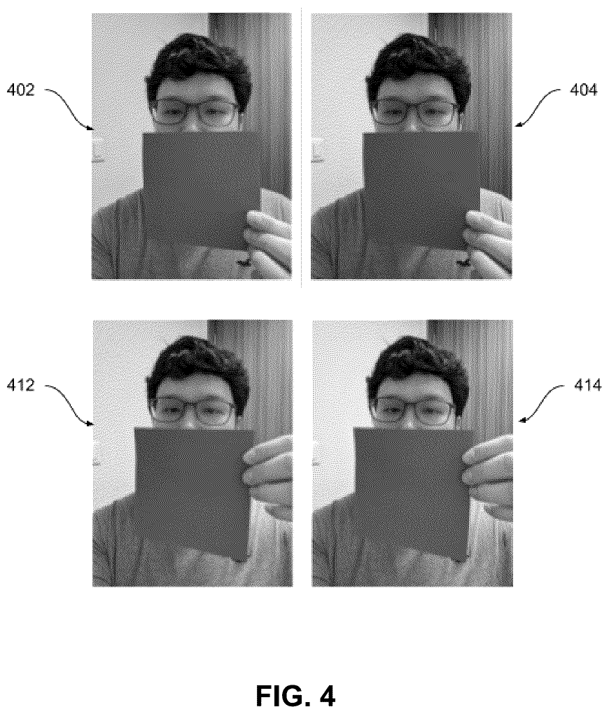

FIG. 4 illustrates an example set of images with automatic white balance adjustment, according to some implementations.

Images 402 and 404 each depict a person holding a red paper that occludes a portion of their face. In image 402, face color calculation is based on the entire detected face, including the face covering (red paper). An AWB algorithm that takes the face color calculation as input is used to generate image 402 from a raw image captured by a camera. Blue shift is observed in image 402. For example, the background wall as well as the face has a blue tinge.

In image 404, face color calculation is based on a face region of interest that excludes the face covering (red paper). An AWB algorithm that takes the face color calculation as input is used to generate image 404 from a raw image captured by a camera. No blue shift is seen in image 404 and the face has a natural color appearance.

Images 412 and 414 each depict a person holding a blue paper that occludes a portion of their face. In image 412, face color calculation is based on the entire detected face, including the face covering (blue paper). An AWB algorithm that takes the face color calculation as input is used to generate image 412 from a raw image captured by a camera. Yellow shift is observed in image 402. For example, the background wall as well as the face has a yellow tinge.

In image 414, face color calculation is based on a face region of interest that excludes the face covering (blue paper). An AWB algorithm that takes the face color calculation as input is used to generate image 414 from a raw image captured by a camera. No yellow shift is seen in image 414 and the face has a natural color appearance.

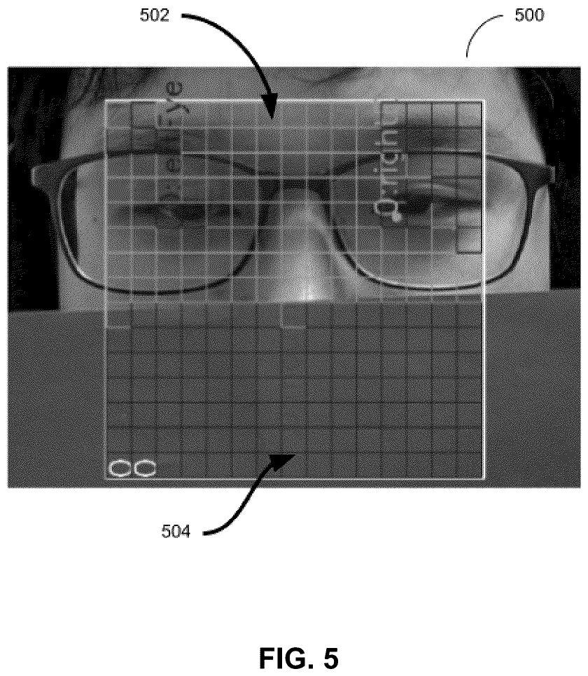

FIG. 5 illustrates an example image of a face 500 with a region of interest obtained according to some implementations. As seen in image 500, the image includes a close-up of a face (top portion) partially occluded by a face covering (bottom portion). The region of interest is illustrated by green rectangles overlaid on the image. The green rectangles correspond to portions of the image where pixels (majority of pixels) correspond to skin region. Non-skin regions (red face covering) in the image are illustrated by blue rectangles overlaid on the image. The blue rectangles correspond to portions of the image where pixels (majority of pixels) correspond to non-skin regions. As illustrated in FIG. 5, implementations described herein identify a region of interest corresponding to skin tone that can be used to apply automatic white balance adjustment to generate an output image.

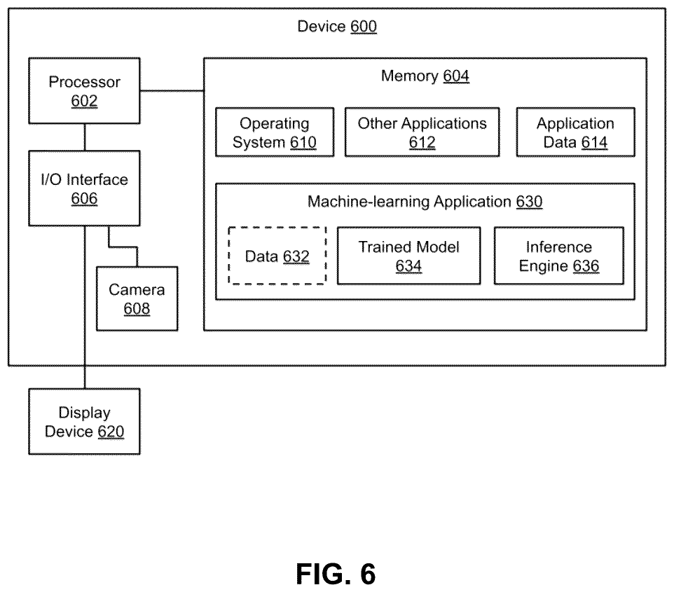

FIG. 6 is a block diagram of an example device 600 which may be used to implement one or more features described herein. In one example, device 600 may be used to implement a client device, e.g., any of client devices 120-126 shown in FIG. 1. Alternatively, device 600 can implement a server system 102 and/or a server device 102. In some implementations, device 600 may be used to implement a client device, a server device, or both client and server devices. Device 600 can be any suitable computer system, server, or other electronic or hardware device as described above.

One or more methods described herein can be run in a standalone program that can be executed on any type of computing device, a program run on a web browser, a mobile application (“app”) run on a mobile computing device (e.g., cell phone, smartphone, tablet computer, wearable device (wristwatch, armband, jewelry, headwear, virtual reality goggles or glasses, augmented reality goggles or glasses, head mounted display, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 600 includes a processor 602, a memory 604, and input/output (I/O) interface 606. Processor 602 can be one or more processors and/or processing circuits to execute program code and control basic operations of the device 600. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems. In some implementations, processor 602 may include one or more co-processors that implement neural-network processing. In some implementations, processor 602 may be a processor that processes data to produce probabilistic output, e.g., the output produced by processor 602 may be imprecise or may be accurate within a range from an expected output. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 604 is typically provided in device 600 for access by the processor 602, and may be any suitable processor-readable storage medium, such as random access memory (RAM), read-only memory (ROM), Electrical Erasable Read-only Memory (EEPROM), Flash memory, etc., suitable for storing instructions for execution by the processor, and located separate from processor 602 and/or integrated therewith. Memory 604 can store software operating on the server device 600 by the processor 602, including an operating system 610, machine-learning application 630, other applications 612, and application data 614. Other applications 612 may include applications such as a data display engine, web hosting engine, image display engine, notification engine, social networking engine, etc. In some implementations, the machine-learning application 630 and other applications 612 can each include instructions that enable processor 602 to perform functions described herein, e.g., the methods of FIG. 3.

Other applications 612 can include, e.g., image editing applications, media display applications, communication applications, web hosting engines or applications, mapping applications, media sharing applications, etc. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 630 may utilize Bayesian classifiers, support vector machines, neural networks, or other learning techniques. In some implementations, machine-learning application 630 may include a trained model 634, an inference engine 636, and data 632. In some implementations, data 632 may include training data, e.g., data used to generate trained model 634. For example, training data may include any type of data such as text, images, audio, video, etc. When trained model 634 is a skin tone classifier, training data may include color images and corresponding labels that indicate a skin tone for each image.

Training data may be obtained from any source, e.g., a data repository specifically marked for training, data for which permission is provided for use as training data for machine-learning, etc. In implementations where one or more users permit use of their respective user data to train a machine-learning model, e.g., trained model 634, training data may include such user data. In implementations where users permit use of their respective user data, data 632 may include permitted data such as images (e.g., photos or other user-generated images).

In some implementations, training data may include synthetic data generated for the purpose of training, such as data that is not based on user input or activity in the context that is being trained, e.g., data generated from simulated photographs or other computer-generated images. In some implementations, machine-learning application 630 excludes data 632. For example, in these implementations, the trained model 634 may be generated, e.g., on a different device, and be provided as part of machine-learning application 630. In various implementations, the trained model 634 may be provided as a data file that includes a model structure or form, and associated weights. Inference engine 636 may read the data file for trained model 634 and implement a neural network with node connectivity, layers, and weights based on the model structure or form specified in trained model 634.

In some implementations, the trained model 634 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc. The model form or structure may specify connectivity between various nodes and organization of nodes into layers.

For example, the nodes of a first layer (e.g., input layer) may receive data as input data 632 or application data 614. Subsequent intermediate layers may receive as input output of nodes of a previous layer per the connectivity specified in the model form or structure. These layers may also be referred to as hidden layers or latent layers.

A final layer (e.g., output layer) produces an output of the machine-learning application. For example, the output may be a skin tone classification for an input image. In some implementations, model form or structure also specifies a number and/or type of nodes in each layer.

In different implementations, trained model 634 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output. In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 634 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 632, to produce a result.

For example, training may include applying supervised learning techniques. In supervised learning, the training data can include a plurality of inputs (e.g., a set of color images) and a corresponding expected output for each input (e.g., a set of groundtruth labels indicating skin tone classification for one or more faces in each image in the set of color images). Based on a comparison of the output of the model with the expected output, values of the weights are automatically adjusted, e.g., in a manner that increases a probability that the model produces the expected output when provided similar input.

Machine-learning application 630 also includes an inference engine 636. Inference engine 636 is configured to apply the trained model 634 to data, such as application data 614, to provide an inference. In some implementations, inference engine 636 may include software code to be executed by processor 602. In some implementations, inference engine 636 may specify circuit configuration (e.g., for a programmable processor, for a field programmable gate array (FPGA), etc.) enabling processor 602 to apply the trained model. In some implementations, inference engine 636 may include software instructions, hardware instructions, or a combination. In some implementations, inference engine 636 may offer an application programming interface (API) that can be used by operating system 610 and/or other applications 612 to invoke inference engine 636, e.g., to apply trained model 634 to application data 614 to generate an inference. For example, the inference for a skin tone classifier model may be a skin tone classification for one or more faces in the image.

Machine-learning application 630 may provide several technical advantages. For example, when trained model 634 is generated based on unsupervised learning, trained model 634 can be applied by inference engine 636 to produce knowledge representations (e.g., numeric representations) from input data, e.g., application data 614. For example, a model trained for image analysis may produce representations of images that have a smaller data size (e.g., 1 KB) than input images (e.g., 10 MB). In some implementations, such representations may be helpful to reduce processing cost (e.g., computational cost, memory usage, etc.) to generate an output (e.g., a label, a classification, etc.).

In some implementations, such representations may be provided as input to a different machine-learning application that produces output from the output of inference engine 636. In some implementations, knowledge representations generated by machine-learning application 630 may be provided to a different device that conducts further processing, e.g., over a network. In such implementations, providing the knowledge representations rather than the images may provide a technical benefit, e.g., enable faster data transmission with reduced cost. In another example, a model trained for clustering documents may produce document clusters from input documents. The document clusters may be suitable for further processing (e.g., determining whether a document is related to a topic, determining a classification category for the document, etc.) without the need to access the original document, and therefore, save computational cost.

In some implementations, machine-learning application 630 may be implemented in an offline manner. In these implementations, trained model 634 may be generated in a first stage, and provided as part of machine-learning application 630. In some implementations, machine-learning application 630 may be implemented in an online manner. For example, in such implementations, an application that invokes machine-learning application 630 (e.g., operating system 610, one or more of other applications 612) may utilize an inference produced by machine-learning application 630, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 634, e.g., to update embeddings for trained model 634.

In some implementations, machine-learning application 630 may be implemented in a manner that can adapt to particular configuration of device 600 on which the machine-learning application 630 is executed. For example, machine-learning application 630 may determine a computational graph that utilizes available computational resources, e.g., processor 602. For example, if machine-learning application 630 is implemented as a distributed application on multiple devices, machine-learning application 630 may determine computations to be carried out on individual devices in a manner that optimizes computation. In another example, machine-learning application 630 may determine that processor 602 includes a GPU with a particular number of GPU cores (e.g., 1000) and implement the inference engine accordingly (e.g., as 1000 individual processes or threads).

In some implementations, machine-learning application 630 may implement an ensemble of trained models. For example, trained model 634 may include a plurality of trained models that are each applicable to the same input data. In these implementations, machine-learning application 630 may choose a particular trained model, e.g., based on available computational resources, success rate with prior inferences, etc. In some implementations, machine-learning application 630 may execute inference engine 636 such that a plurality of trained models is applied. In these implementations, machine-learning application 630 may combine outputs from applying individual models, e.g., using a voting-technique that scores individual outputs from applying each trained model, or by choosing one or more particular outputs. Further, in these implementations, machine-learning application 630 may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 610 or one or more applications 612.

In different implementations, machine-learning application 630 can produce different types of outputs. For example, machine-learning application 630 can provide representations or clusters (e.g., numeric representations of input data), images or video (e.g., with one or more human faces of different skin tones), etc. In some implementations, machine-learning application 630 may produce an output based on a format specified by an invoking application, e.g., operating system 610 or one or more applications 612. In some implementations, an invoking application may be another machine-learning application. For example, such configurations may be used in generative adversarial networks, where an invoking machine-learning application is trained using output from machine-learning application 630 and vice-versa.

Any of software in memory 604 can alternatively be stored on any other suitable storage location or computer-readable medium. In addition, memory 604 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 604 and any other type of storage (magnetic disk, optical disk, magnetic tape, or other tangible media) can be considered “storage” or “storage devices.”

I/O interface 606 can provide functions to enable interfacing the server device 600 with other systems and devices. Interfaced devices can be included as part of the device 600 or can be separate and communicate with the device 600. For example, network communication devices, storage devices (e.g., memory and/or database 106), and input/output devices can communicate via I/O interface 606. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 606 can include one or more display devices 620 that can be used to display content, e.g., images, video, and/or a user interface of an output application as described herein. Display device 620 can be connected to device 600 via local connections (e.g., display bus) and/or via networked connections and can be any suitable display device. Display device 620 can include any suitable display device such as an LCD, LED, or plasma display screen, CRT, television, monitor, touchscreen, 3-D display screen, or other visual display device. For example, display device 620 can be a flat display screen provided on a mobile device, multiple display screens provided in a goggles or headset device, or a monitor screen for a computer device.

The I/O interface 606 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

Camera 608 may be any camera that includes one or more image sensors, e.g., a complementary metal-oxide-semiconductor (CMOS) or other sensor that captures image data from a scene. For example, camera 608 may capture a raw image of the scene in red-green-blue (RGB) format where individual pixels each have a respective color value. In some implementations, device 600 may include a plurality of cameras, e.g., one or more front cameras and/or rear cameras, etc.

For ease of illustration, FIG. 6 shows one block for each of processor 602, memory 604, I/O interface 606, camera 608, display device 620, and software blocks 610 and 630. These blocks may represent one or more processors or processing circuitries, operating systems, memories, I/O interfaces, applications, and/or software modules. In other implementations, device 600 may not have all of the components shown and/or may have other elements including other types of elements instead of, or in addition to, those shown herein. While some components are described as performing blocks and operations as described in some implementations herein, any suitable component or combination of components of environment 100, device 600, similar systems, or any suitable processor or processors associated with such a system, may perform the blocks and operations described.

Methods described herein can be implemented by computer program instructions or code, which can be executed on a computer. For example, the code can be implemented by one or more digital processors (e.g., microprocessors or other processing circuitry) and can be stored on a computer program product including a non-transitory computer readable medium (e.g., storage medium), such as a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (Saas) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

Although the description has been described with respect to particular implementations thereof, these particular implementations are merely illustrative, and not restrictive. Concepts illustrated in the examples may be applied to other examples and implementations.

In situations in which certain implementations discussed herein may collect or use personal information about users (e.g., user data, information about a user's social network, user's location and time at the location, user's biometric information, user's activities and demographic information), users are provided with one or more opportunities to control whether information is collected, whether the personal information is stored, whether the personal information is used, and how the information is collected about the user, stored and used. That is, the systems and methods discussed herein collect, store and/or use user personal information specifically upon receiving explicit authorization from the relevant users to do so. For example, a user is provided with control over whether programs or features collect user information about that particular user or other users relevant to the program or feature. Each user for which personal information is to be collected is presented with one or more options to allow control over the information collection relevant to that user, to provide permission or authorization as to whether the information is collected and as to which portions of the information are to be collected. For example, users can be provided with one or more such control options over a communication network. In addition, certain data may be treated in one or more ways before it is stored or used so that personally identifiable information is removed. As one example, a user's identity may be treated so that no personally identifiable information can be determined. As another example, a user device's geographic location may be generalized to a larger region so that the user's particular location cannot be determined.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

1. A computer-implemented method to adjust white balance in an image, the method comprising:
detecting, by a processor, a face in the image, wherein the face corresponds to a plurality of pixels;
determining a region of interest (ROI) for the face, wherein the region of interest excludes at least one pixel from the plurality of pixels that correspond to the face;
performing a face color calculation for the face based on the region of interest for the face; and
adjusting the white balance in the image based on the face color calculation to obtain an output image.

2. The computer-implemented method of claim 1, wherein determining the region of interest comprises:
comparing a pixel value of each pixel of the face with a set of skin tone region parameters;
if the pixel value is in the set of skin tone region parameters, including the pixel in the region of interest; and
if the pixel value is not in the set of skin tone region parameters, excluding the pixel from the region of interest.

3. The computer-implemented method of claim 1, further comprising, prior to determining the region of interest, determining a skin tone classification for the face.

4. The computer-implemented method of claim 3, further comprising identifying a particular set of skin tone region parameters based on the skin tone classification for the face, and wherein determining the region of interest comprises:
comparing a pixel value of each pixel of the face with a set of skin tone region parameters;
if the pixel value is in the set of skin tone region parameters, including the pixel in the region of interest; and
if the pixel value is not in the set of skin tone region parameters, excluding the pixel from the region of interest.

5. The computer-implemented method of claim 3, wherein determining the skin tone classification is performed using a skin tone classifier that takes as input the plurality of pixels of the face, and further comprising preprocessing the plurality of pixels of the face, wherein the preprocessing includes adjusting one or more statistics of the image prior to providing the image to the skin tone classifier.

6. The computer-implemented method of claim 1, wherein the face is at least partially occluded by a face covering, and wherein the region of interest excludes at least a portion of the face covering.

7. The computer-implemented method of claim 1, wherein the image includes a plurality of faces and wherein determining the region of interest and performing the face color calculation are repeated for each of the plurality of faces.

8. The computer-implemented method of claim 7, further comprising determining that a particular face of the plurality of faces does not meet a size threshold based on a total number of pixels corresponding to the particular face being less than a threshold number of pixels, wherein the particular face is removed prior to determining the region of interest and performing the face color calculation.

9. A computing device comprising:
a processor; and
a memory coupled to the processor, with instructions stored thereon that, when executed by the processor, cause the processor to perform operations comprising:
detecting a face in an image, wherein the face corresponds to a plurality of pixels;
determining a region of interest (ROI) for the face, wherein the region of interest excludes at least one pixel from the plurality of pixels that correspond to the face;
performing a face color calculation for the face based on the region of interest for the face; and
adjusting the white balance in the image based on the face color calculation to obtain an output image.

10. The computing device of claim 9, wherein determining the region of interest comprises:
comparing a pixel value of each pixel of the face with a set of skin tone region parameters;
if the pixel value is in the set of skin tone region parameters, including the pixel in the region of interest; and
if the pixel value is not in the set of skin tone region parameters, excluding the pixel from the region of interest.

11. The computing device of claim 9, wherein the operations further comprise, prior to determining the region of interest, determining a skin tone classification for the face.

12. The computing device of claim 11, wherein the operations further comprise identifying a particular set of skin tone region parameters based on the skin tone classification for the face, and wherein determining the region of interest comprises:
comparing a pixel value of each pixel of the face with a set of skin tone region parameters;
if the pixel value is in the set of skin tone region parameters, including the pixel in the region of interest; and
if the pixel value is not in the set of skin tone region parameters, excluding the pixel from the region of interest.

13. The computing device of claim 11, wherein determining the skin tone classification is performed using a skin tone classifier that takes as input the plurality of pixels of the face, and further comprising preprocessing the plurality of pixels of the face, wherein the preprocessing includes adjusting one or more statistics of the image prior to providing the image to the skin tone classifier.

14. The computing device of claim 11, wherein the image includes a plurality of faces and wherein determining region of interest and performing face color calculation are repeated for each of the plurality of faces.

15. The computing device of claim 14, further comprising determining that a particular face of the plurality of faces does not meet a size threshold based on a total number of pixels corresponding to the particular face being less than a threshold number of pixels, wherein the particular face is removed from the plurality of faces prior to determining the region of interest and performing the face color calculation.

16. A non-transitory computer-readable medium, with instructions stored thereon that, when executed by a processor, cause the processor to perform operations comprising:
detecting a face in an image, wherein the face corresponds to a plurality of pixels;
determining a region of interest (ROI) for the face, wherein the region of interest excludes at least one pixel from the plurality of pixels that correspond to the face;
performing a face color calculation for the face based on the region of interest for the face; and
adjusting the white balance in the image based on the face color calculation to obtain an output image.

17. The non-transitory computer-readable medium of claim 16, wherein determining the region of interest comprises:
comparing a pixel value of each pixel of the face with a set of skin tone region parameters;
if the pixel value is in the set of skin tone region parameters, including the pixel in the region of interest; and
if the pixel value is not in the set of skin tone region parameters, excluding the pixel from the region of interest.

18. The non-transitory computer-readable medium of claim 16, wherein the operations further comprise, prior to determining the region of interest, determining a skin tone classification for the face.

19. The non-transitory computer-readable medium of claim 16, wherein the operations further comprise identifying a particular set of skin tone region parameters based on a skin tone classification for the face, and wherein determining the region of interest comprises:
comparing a pixel value of each pixel of the face with a set of skin tone region parameters;
if the pixel value is in the set of skin tone region parameters, including the pixel in the region of interest; and
if the pixel value is not in the set of skin tone region parameters, excluding the pixel from the region of interest.

20. The non-transitory computer-readable medium of claim 16, wherein the operations further comprise:
determining a skin tone classification for the face prior to determining the region of interest, wherein determining the skin tone classification is performed using a skin tone classifier that takes as input the plurality of pixels of the face; and
preprocessing the plurality of pixels of the face, wherein the preprocessing includes adjusting one or more statistics of the image prior to providing the image to the skin tone classifier.
